(19) United States
(12) Patent Application Publication
(10) Pub. No.: US 2013/0182551 A1
(43) Pub. Date: Jul. 18, 2013

(54) OPTICAL DISK DEVICE AND OPTICAL PICKUP THEREFOR

(71) Applicant: HITACHI MEDIA ELECTRONICS CO., LTD., Oshu-shi (JP)

(72) Inventors: Daisuke TOMITA, Yokohama-shi (JP); Jun HATO, Fujisawa-shi (JP); Kenji KIYA, Fujisawa-shi (JP); Tsukasa TAKAHASHI, Yokohama-shi (JP)

(73) Assignee: HITACHI MEDIA ELECTRONICS CO., LTD., Oshu-shi (JP)

(21) Appl. No.: 13/721,200

(22) Filed: Dec. 20, 2012

(30) Foreign Application Priority Data
Jan. 13, 2012 (JP) 2012-005190

(51) Int. Cl. G11B 7/127

(52) U.S. Cl. CPC G11B 7/127
USPC 369/121

(57) ABSTRACT

When an optical pickup used an optical disk device is formed, a PWB (Printed Wiring Board) which serves as a top cover is used at at least a part of a surface of a housing which houses the optical pickup, the surface facing an optical disk. The PWB (Printed Wiring Board) is adapted to seal components inside the optical pickup, and to reduce the flexure of FPC (Flexible Printed Circuits). Moreover, the printed wiring board is provided with a connector which allows the connection of FPC for connection to circuits outside the optical pickup.

Consequently, the slack of the FPC can be eliminated, and optical members provided inside the optical pickup can be protected without using a metal cover.

### CLAIMS OF PRIORITY

The present application claims priority from Japanese patent application serial no. JP2012-005190, filed on Jan. 13, 2012, the content of which is hereby incorporated by reference into this application.

### BACKGROUND OF THE INVENTION

The present invention relates to an optical disk device and an optical pickup used therefor. The invention more particularly relates to an optical disk device which is mounted in a notebook-type personal computer, etc., is suitable for a thin-shaped model, is inexpensive, and is manufactured with ease. The invention also relates to an optical pickup used for the optical disk device.

Conventionally, optical disk devices achieve widespread use as devices for reading and writing digital information. Examples of such optical disk devices include a CD (Compact Disk) drive unit, a DVD (Digital Versatile Disk) drive unit, and particularly a recent BD (Blu-ray Disc) drive unit.

These optical disk devices are operated as follows. An optical disk is rotated by a spindle motor built in a drive. The rotating optical disk is then irradiated with laser light from a laser diode that is a light source incorporated in an optical pickup, and the light reflected from the optical disk is read by a pickup lens and is recognized as information.

It can be said that such an optical pickup is the most important component for the optical disk device composed of a laser light source, a light receiving element and precise mechanical parts.

With the recent popularization of notebook-type personal computers, in particular, devices themselves are getting more lightweight and slimmer, and thin-shaped optical pickups are also being developed.

For example, photographs of an optical pickup for a slim BD drive are disclosed in FIG. 1 of “Slim-type BD drive having a thickness of 12.7 mm”, [online], Horinouchi, et al., Panasonic Technical Journal, Vol. 54, No. 3, October 2008 [searched on 28 Dec. 2011], Internet <URL:http://panasonic.co.jp/ptj/v5403/pdf/p0104.pdf>. In addition, JP-A-2011-165251 has disclosed a shape of an optical pickup in FIG. 2 thereof.

With the conventional production of optical pickups of optical disk devices, the slack of internal FPC (Flexible Printed Circuits) is permitted and it was a common practice to provide a metal cover made of aluminum or stainless steel (SUS) above the optical pickup (the surface facing the optical disk) for the purpose of protection of optical members provided inside the optical pickup.

However, there are the following problems: the metal cover has a shape adapted to protect the area which is substantially the same as that of the optical pickup, and thus covers the wide area, leading to high cost; and the number of parts of the optical pickup increases.

The present invention has been made to solve the abovementioned problems. A primary object of the present invention is to provide an optical pickup used for an optical disk device which is adapted to eliminate the slack of FPC and protect optical members disposed inside the optical pickup, without providing a metal cover when the optical pickup is formed.

### SUMMARY OF THE INVENTION

The optical disk device according to the present invention uses a PWB (Printed Wiring Board), which serves as a top cover, at at least a part of a surface of a housing which houses an optical pickup, the surface facing an optical disk.

In addition, the PWB (Printed Wiring Board) is adapted to seal components inside the optical pickup, and to reduce the flexure of FPC (Flexible Printed Circuits).

Moreover, the printed wiring board is provided with a connector which allows the connection of FPC for connection to circuits outside the optical pickup.

In this manner, the present invention can provide an optical pickup for an optical disk device which is adapted to eliminate the slack of FPC and protect optical members disposed inside the optical pickup, without using a metal cover when the optical pickup is formed.

### BRIEF DESCRIPTION OF DRAWINGS

FIG. 1 is a perspective view of the whole optical disk device according to one embodiment of the present invention;

FIG. 2 is a top view of the whole optical disk device according to one embodiment of the present invention;

FIG. 3A is a top view (1) of an optical pickup according to the conventional art;

FIG. 3B is a top view (2) of an optical pickup according to the conventional art;

FIG. 4A is a top view (1) of an optical pickup according to this embodiment; and

FIG. 4B is a top view (2) of an optical pickup according to this embodiment.

### DESCRIPTION OF THE PREFERRED EMBODIMENT

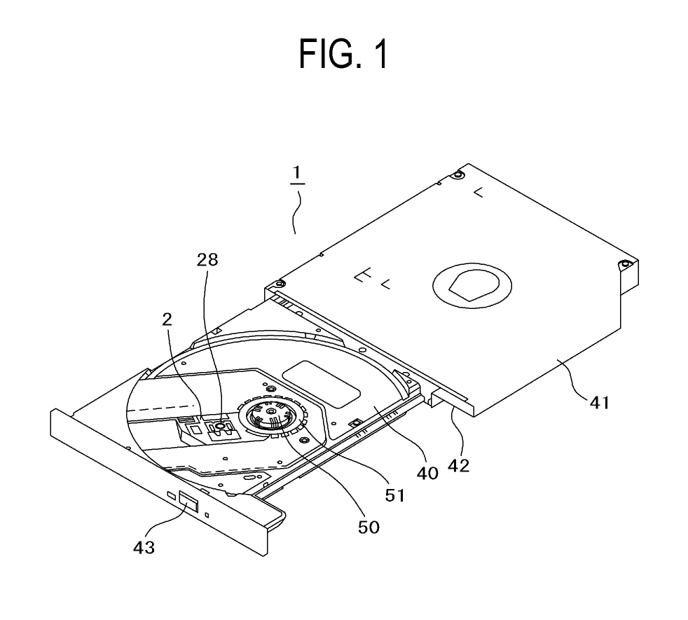

Embodiments of the present invention will be described with reference to FIGS. 1 to 4B as below.

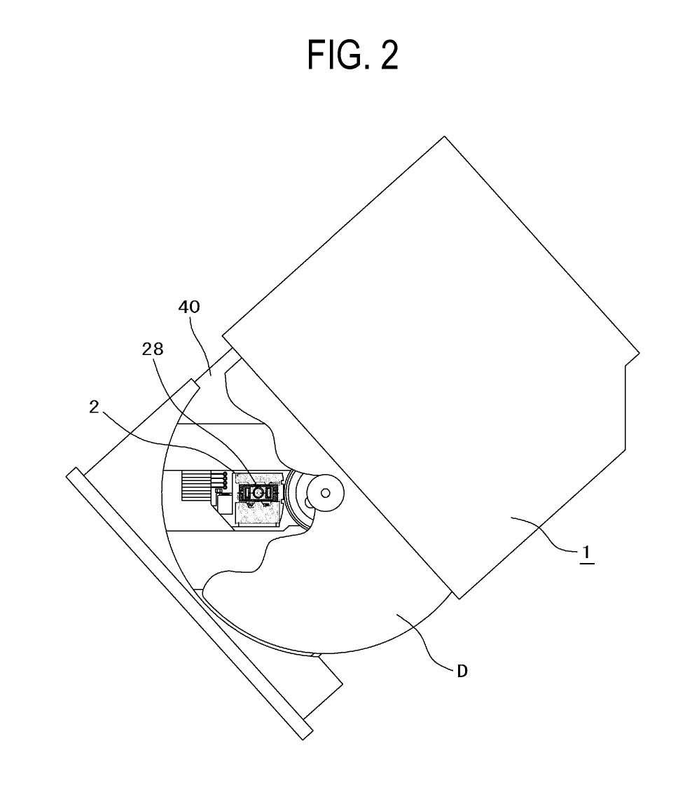

First of all, a structure of an optical disk device will be described with reference to FIGS. 1 and 2.

FIG. 1 is a perspective view of the whole optical disk device according to one embodiment of the present invention.

FIG. 2 is a top view of the whole optical disk device according to one embodiment of the present invention.

The optical disk device according to this embodiment is a thin (slim type) drive unit with which a notebook PC or the like is equipped. As shown in FIG. 1, the optical disk device has a chassis section constituted of a top chassis 41 and a bottom chassis 42 fitted therein. The optical disk device is adapted to draw out a tray 40 on which an optical disk is placed by allowing a user to press an eject button 43, or accepting an instruction for eject operation from a personal computer so that a mechanical unit is operated.

To read/write data from/to an optical disk such as CD, DVD and BD, an optical disk is fitted to a chuck 50 of a shaft portion of a turn table 51 in place and the tray 40 is then inserted into the chassis section. In this state, if the optical disk is irradiated with a laser beam from an objective lens 28 of an optical pickup 2, the optical disk device can read/write the data. The turn table is adapted to rotate by a spindle motor (not shown) during a data reading operation or a data writing operation.

FIG. 2 is a top view of the optical disk device with an optical disk D inserted. FIG. 2 also illustrates the optical pickup 2 below the optical disk D, with a portion of the optical disk D cut away, showing the optical pickup 2.

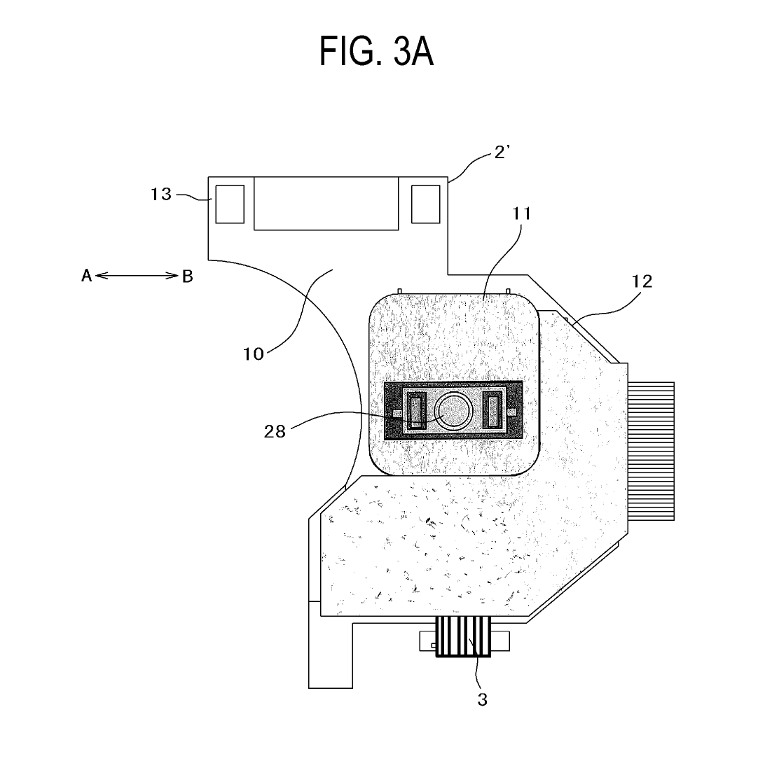

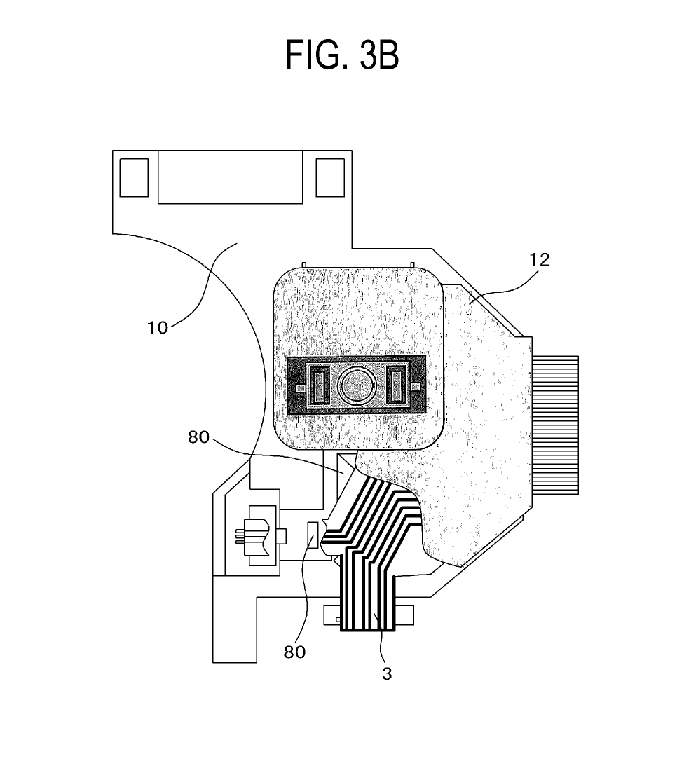

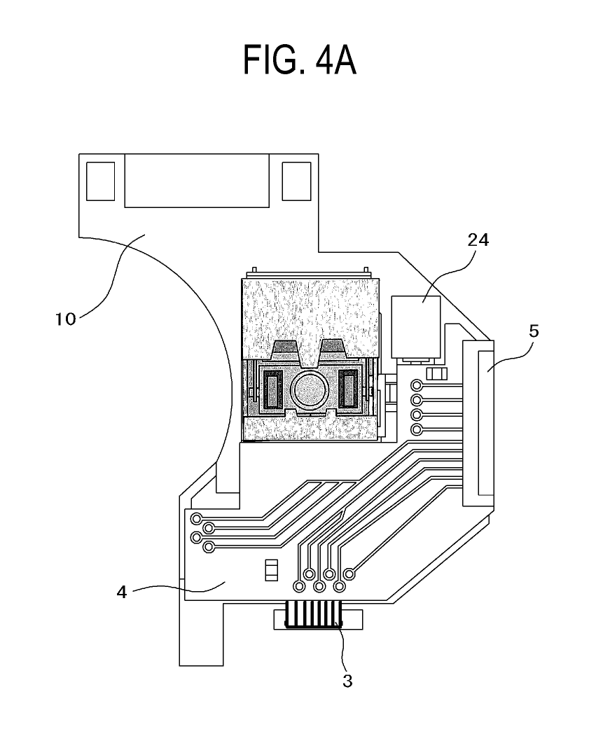

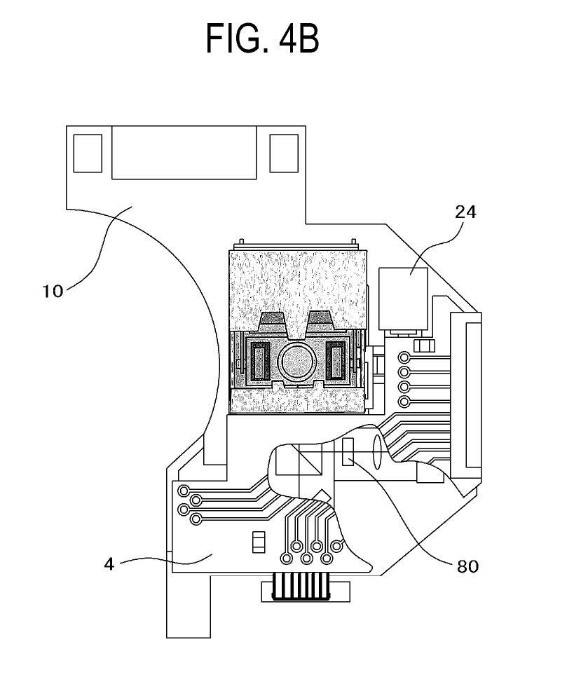

Next, the structure of the optical pickup of the optical disk device according to this embodiment will be described with reference to FIGS. 3A to 4B in contrast with the conventional art.

FIGS. 3A and 3B are top views each illustrating an optical pickup according to the conventional art.

FIGS. 4A and 4B are top views each illustrating the optical pickup according to this embodiment.

FIG. 3A illustrates an optical pickup 2′ according to the conventional art as viewed from the top (in other words, as viewed from the surface that faces the optical disk D). The optical pickup 2′ is formed with an opening 13 through which a main shaft is passed, and is adapted to move in an AB direction by a stepping motor (not illustrated) according to an access position to access the optical disk D. Here, an A-direction is the direction toward the center of rotation while a B-direction is the direction toward the outer circumference.

The optical pickup 2′ according to the conventional art has optical components 80 arranged within a pickup housing 10. The optical components inside the pickup housing 10 are sealed by a rectangular metal cover 11 disposed around a pickup lens 28, and a L-shaped metal cover 12 that comes in contact with two sides of the rectangular metal cover 11. The rectangular metal cover 11 is formed with an opening at a position corresponding to the pickup lens 28 so as to allow a laser beam to be irradiated in the direction of the optical disk D.

Here, FIG. 3B illustrates the optical components 80 with a portion of the L-shaped metal cover 12 of FIG. 3A cut away, showing the internal optical components 80.

FPC (Flexible Printed Circuits) 3 are arranged in the optical pickup 2′ to connect the internal optical components to external electric circuits. The FPC 3 has a structure in which an adhesive layer is formed on a film-like insulator (base film) having a thickness of from 12 μm to 50 μm, and a conductive foil having an approximate thickness of from 12 μm to 50 μm is further formed on the adhesive layer. Thus, the FPC 3 is a printed circuit board that is flexible and largely deformable. For the purpose of protection, the FPC 3 is covered with an insulator with the exception of terminal sections and soldered portions. In addition, the FPC 3 is repeatedly deformable with low force. Even if the FPC 3 is deformed, the FPC 3 will maintain the electrical characteristics thereof. For material of the FPC 3, in general, a polyimide film that is called a cover lay, or a photo solder resist film, is used as the insulator, and copper is used as a conductor.

Moreover, the metal cover 12 for the optical pickup 2′ according to the conventional art has not only a function of sealing the optical components 80, but also a function of holding the FPC 3 to avoid slack.

By contrast, although the electrical/optical characteristics of the optical pickup 2 according to this embodiment are the same as those of the optical pickup 2′ according to the conventional art, the implementation method is changed. Specifically, a PWB (Printed Wiring Board) 4 is used as the top cover in place of the L-shaped metal cover 12, with the PWB having a shape the same as the metal cover 12.

This PWB 4 is made by installing wiring in a plate which uses an insulating base material having no flexibility; therefore PWB 4 is also said to be a rigid board in comparison with FPC. As shown in FIG. 4B, the PWB 4 for the optical pickup 2 according to this embodiment seals the optical components 80 to prevent the immersion of foreign matters and hold the FPC 3.

Here, FIG. 4B illustrates the optical components 80 with a portion of the PWB 4 of FIG. 4A cut away, showing the internal optical components 80.

In addition, the PWB 4 is provided with a connector 5 in the outer circumferential direction of the optical disk D to allow the connection of a FPC for electrical connection to external electric circuits. Moreover, for the implementation of the optical pickup 2 by use of the PWB 4 of this embodiment, the stepping motor 24 is provided to expose thereabove. The stepping motor 24 serves to operate a collimator lens to correct for drive spherical aberration when a BD disc is read. Thus, the optical pickup 2 is cooled by the air flow caused by the rotation of the optical disk D.

According to this embodiment, the optical pickup 2 is implemented by employing the PWB having the same shape in place of the L-shaped metal cover 12. This eliminates the need for using an expensive metal cover, reduces the number of parts, and makes the production easy. In addition, the optical pickup 2 is provided with the connector 5 to enable wiring to the outside through the FPC, and therefore also has the advantage that at the time of carrying, it is not necessary to concurrently carry the FPC which is a long cable, thus achieving the high portability.

Incidentally, the optical pickup for the slim-type optical disk device is taken as an example in this embodiment. However, the present invention is not limited to this. The present invention can also be applied to an optical pickup of the other type of optical disk device such as a half-height type optical disk device.

What is claimed is:

1. An optical disk device which reads/writes information by rotating an optical disk and irradiating the optical disk with a laser beam from an optical pickup, wherein,
a printed wiring board which serves as a top cover is used at at least a part of a surface of a housing which houses the optical pickup, the surface facing the optical disk; and
a component disposed in the optical pickup is sealed by the printed wiring board.

2. The optical disk device according to claim 1, wherein
the printed wiring board is provided with a connector which allows the connection of a wiring member for connection to circuits outside the optical pickup.

3. An optical pickup for an optical disk device that reads/writes information by rotating an optical disk and irradiating the optical disk with a laser beam from the optical pickup, wherein,
a printed wiring board which serves as a top cover is used at at least a part of a surface of a housing which houses the optical pickup, the surface facing the optical disk; and
a component disposed in the optical pickup is sealed by the printed wiring board.

4. The optical pickup according to claim 3, wherein
the printed wiring board is provided with a connector which allows the connection of a wiring member for connection to circuits outside the optical pickup.
